(19) United States
(12) Patent Application Publication
(10) Pub. No.: US 2009/0089474 A1
(43) Pub. Date: Apr. 2, 2009

(54) MOTHERBOARD FOR SUPPORTING DIFFERENT TYPES OF MEMORY

(75) Inventors: YING-TSO LAI, Tu-Cheng (TW); SHOU-KUO HSU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/954,235

(22) Filed: Dec. 12, 2007

(30) Foreign Application Priority Data
Sep. 28, 2007 (CN) 200710201901.7

(51) Int. Cl. G06F 13/00

(52) U.S. Cl. 710/301

(57) ABSTRACT

An exemplary motherboard for supporting different types of memory includes a driving module, a first slot, a second slot, and a transmission line connected the driving module, the first slot and the second slot in turn. The first slot is arranged for mounting a first type of memory. The second slot is arranged for mounting a second type of memory. The first memory and the second memory are alternatively mounted on the motherboard. The transmission line is grounded via a capacitor for eliminating echo signals generated by the first and second type memories. The motherboard for supporting different memory modes satisfies different type memories, and maintains integrality of signals transmitted therein.

### BACKGROUND

1. Field of the Invention

The present invention relates to motherboards, and particularly to a motherboard for supporting different types of memory.

2. Description of Related Art

Currently, a typical personal computer comprises a motherboard, interface cards, and peripheral accessories. The motherboard is the heart of the personal computer. On the motherboard, in addition to the central processing unit (CPU), the chip set, and the slots for installing the interface cards, it further includes memory module slots for installing memory modules.

Due to constant change in the computer industry, memories used in the computer have changed from DDR2 (Double Data Ram II) used in the past to higher speed memories such as DDR3 (Double Data Ram III).

Because DDR2 is cheaper than DDR3, the main board with DDR2 is still in demand in the market. The difference in operating DDR2 and DDR3 includes: DDR2 utilizes 1.8V VDD and 0.9V VTT, while DDR3 utilizes 1.5V VDD and 0.75V VTT; and DDR2 utilizes a terminal resistor arranged on the motherboard to eliminate echo signals generated by the memory, while DDR3 has a built-in terminal resistor and the terminal resistor arranged on the motherboard will influence an effect of the built-in terminal resistor.

What is needed is to provide a motherboard capable of eliminating echo signals generated by different types of memory mounted on the motherboard.

### SUMMARY

An exemplary motherboard for supporting different types of memory includes a driving module, a first slot, a second slot, and a transmission line connected the driving module, the first slot and the second slot in turn. The first slot is arranged for mounting a first type of memory. The second slot is arranged for mounting a second type of memory. The first memory and the second memory are alternatively mounted on the motherboard. The transmission line is grounded via a terminal capacitor for eliminating echo signals generated by the first and second type memories.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is a diagram of part of a motherboard for supporting different types of memory including a slot and a capacitor, in accordance with an embodiment of the present invention; and

FIG. 2 is a graph comparing waveforms received by the slot of FIG. 1 with waveforms received by a slot of a motherboard as in FIG. 1 but using a resistor instead of the capacitor.

### DETAILED DESCRIPTION

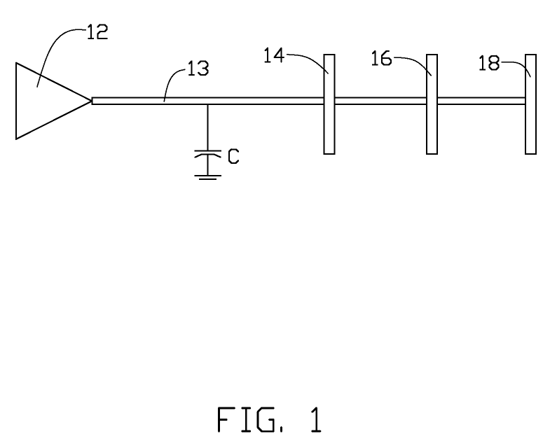

Referring to FIG. 1, a motherboard for supporting different types of memory in accordance with an embodiment of the present invention includes a driving module 12, a transmission line 13, a first slot 14, a second slot 16, a third slot 18, and a terminal capacitor C. The driving module 12 is a north bridge mounted on the motherboard. The first slot 14 and the second slot 16 are used for installing a first memory, such as a DDR2 memory. The third slot 18 is used for installing a second memory, such as a DDR3 memory. The first memory and the second memory are alternatively mounted on the motherboard. The transmission line 13 has an end coupled to the driving circuit 12 and an opposite end coupled to the first slot 14, second slot 16 and third slot 18. The terminal capacitor C has an end connected to the transmission line 13 and an opposite end grounded for eliminating echo signals generated by the first and second type memories.

In this embodiment of the invention, the terminal capacitor C is connected between the driving module 12 and the first slot 14. The terminal capacitor C also can be connected between the first slot 14 and the second slot 16, between the second slot 16 and the third slot 18, and after the third slot 18.

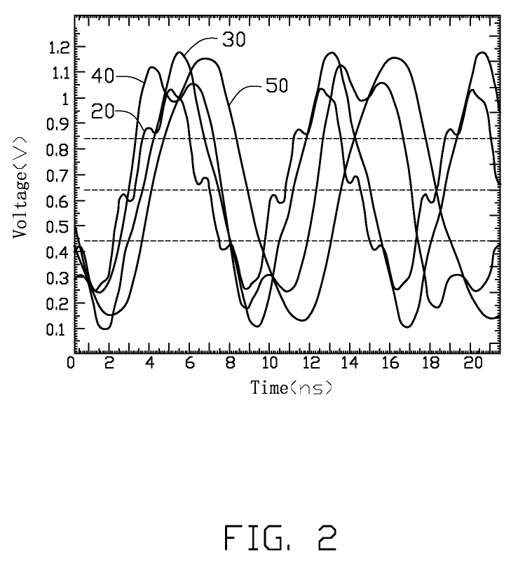

Referring to FIG. 2, curves 20 and 40 are voltage waveforms obtained at the first slot 14 and the third slot 18 respectively, when the transmission line 13 is connected in a conventional manner to a terminal resistor and the first and second type memories, which are mounted in the first and the third slots 14 and 18. Curves 30 and 50 are voltage waveforms obtained at the first slot 14 and the third slot 18 respectively, when the transmission line 13 is connected to the terminal capacitor C (as in FIG. 1) and the first and second type memories, which are mounted in the first and the third slots 14 and 18. Comparing curves 20 and 40 with curves 30 and 50, the terminal capacitor C eliminates echo signals generated by the first and second type memories mounted in the first and the third slots 14 and 18.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A motherboard for supporting different types of memory comprising:
a driving module;
a first slot configured for mounting a first type memory;
a second slot configured for mounting a second type memory;
a transmission line coupling the driving module to the first and second slots; and
a terminal capacitor having an end connected to the transmission line and an opposite end grounded for eliminating echo signals generated by the first and second type memories.

2. The motherboard as claimed in claim 1, wherein the driving module is a north bridge mounted on the motherboard.

3. The motherboard as claimed in claim 1, wherein the first slot is a DDR2 slot, and the second slot is a DDR3 slot.

4. The motherboard as claimed in claim 1, wherein a capacitance of the terminal capacitor is 33 pF.
